(19) United States
(12) Patent Application Publication
(10) Pub. No.: US 2023/0087945 A1
(43) Pub. Date: Mar. 23, 2023

(54) protective cage for a cash machine

(71) Applicant: SAIMA SICUREZZA S.P.A., AREZZO (IT)

(72) Inventor: Rinaldo RINALDI, AREZZO (IT)

(21) Appl. No.: 17/930,425

(22) Filed: Sep. 8, 2022

(30) Foreign Application Priority Data
Sep. 23, 2021 (IT) 102021000024480

(51) Int. Cl. E05G 1/024; E05G 1/04

(52) U.S. Cl. CPC E05G 1/024; E05G 1/04

(57) ABSTRACT

The present invention relates to a protective cage for a cash machine comprising for at least one part thereof at least one protective screen (20, 21) constituted by at least two metallic layers, between which one layer of ceramic material is interposed.

### SCOPE OF THE INVENTION

The present invention concerns the technical field relative to protecting cash machines. In particular, the invention refers to an innovative protection system to protect a cash machine from break-in attempts.

### A BRIEF OUTLINE OF THE PRIOR ART

It is well known that cash machines are often subject to theft attacks. Such attacks involve the use of explosive and the use of cutting wheels.

The cash machine protections have been known for a long time and are in the form of protective structures, for example cages, whose purpose is to protect the cash machine from explosions and cuts.

FIG. 1 and FIG. 2 show a prior art solution with reference to a cash machine protection.

The explosive in use was, in the past, in the form of a gas that was injected into predetermined points of the cash machine.

However, the gas is easily volatile so it is not easy to inject it correctly to control an explosion. In addition, it is unstable and therefore cases of accidental explosions with serious consequences for the criminals have not been uncommon.

It is precisely for this reason that solid explosive is now used, which even has a greater deflagration power. However, an explosion that is too strong could also cause the destruction of money so, generally, the criminal controls the amount of explosive by attempting to weaken the structure by cutting it.

The protection currently known is that reported in FIG. 1 and in FIG. 2 which protection is in the form of a protective cage made of anti-cutting and anti-explosion material, such as steel.

The cage overall encloses the cash machine (shown in the figure numbered 1 and on a dotted line) and the cage comprises an upper closing rod 10 and a lower closing rod 9.

The two said rods are rotatable between an opening position and a closing position. For example, the lower rod 9 is shown partially open while the upper rod 10 is shown closed. The rods end with a perforated plate into which the pin 8 for locking is inserted and with a pin 8 that is fixed in the locking position through a lock 7 (or closing means in general).

FIG. 1 shows, in fact, the pin relating to the lower rod raised so as to allow the lower rod to be opened, and the pin relating to the upper rod 10 closed and locked in position so as to prevent the opening of the rod 10. The two rods are connected to the rest of the cage structure formed by:
Two upper bands 2;
Two rear bands 3;
The four side fixing plates 4 (there are two on each side) and to which both the upper and lower rods and said bands 2 and 3 are connected.
Two rest plates 5 are then provided which connect to the rest of the structure through two uprights 5';
The cage, as a whole, is at least partly made of metal, generally steel.

In the attached FIGS. 1 and 2, numbered 1 on a dotted line, the cash machine is reported enveloped by said protective cage.

More in particular, the two rods 9 and 10 only close the door of the safe; they are opened manually by the operator after unlocking the lock 7 with a key and after lifting the pins 6 and 8.

The rest of the structure is fixed to the ground with screws on the holes in the rest feet 5. The plates 4 are glued to the walls of the cash machine with two-component epoxy adhesive.

The locks 7, the locking system with pins 6 and 8, on the other side the rod hinges 9 and 10 and the adjustable rods 5' which connect with the feet 5 are firmly fixed on these plates 4. The rods 5' are adjustable to allow the plates 4 to be positioned at different height for the various cash machine models.

The purpose of the feet 5 is to support the plates until the glue has dried, as well as to hold the cage to the ground during the explosion or in the event of an attempt to rip the cash machine tied with a cable to a means of transport (a known technique performed using similar methods).

This type of solution, although functional, is not optimal to protect against cutting. The criminal could attempt to cut the lower and/or upper rods or intervene by cutting in the areas of the pins in order to gain access to the cash machine.

Although strong metals or metal alloys, such as steel, are used, the use of special grinding wheels and/or blowtorch does not prevent cutting.

### SUMMARY OF THE INVENTION

It is therefore the object of the present invention to provide an innovative protective cage for a cash machine that solves the aforementioned technical drawbacks.

In particular, it is an object of the present invention to realize a cage that is safer from the cutting problem and that, at the same time, is always safe from the risk of explosions. These and other objects are therefore achieved with the present protective cage for a cash machine in accordance with claim 1.

The present protective cage for a cash machine comprises for at least one part thereof at least one anti-cutting screen (20-21) constituted by at least two metallic layers between which at least one layer of ceramic material is interposed.

In this way, all the above-mentioned drawbacks are easily solved.

In particular, the use of a protective screen thus made greatly increases the cut-resistance of those critical parts that are covered with such an anti-cutting protective screen.

In fact, the realization of a sandwich that includes metal-ceramic makes the cutting very difficult because the grinding wheel that is suitable for cutting the metal mixes with the ceramic as soon as it intercepts it, losing its cutting capabilities. The blowtorch that may be used is hindered by the high temperature resistance of the ceramic material.

This type of protection is therefore effective in preventing the cutting and can be applied, e.g. welded, in one or more areas of the cage as required.

Advantageously, said metallic layers can also be metal alloys, for example in steel.

Advantageously, said layer of ceramic material can be stoneware, for example porcelain.

Advantageously, said ceramic material can be in the form of ceramic tiles, for example stoneware tiles.

Advantageously, said protective cage can comprise first closing means (6, 7) and at least one rod (10) rotatable between an opening position and a closing position.

Advantageously, said rod can comprise second closing means suitable for engaging with said first closing means to lock said rod when it is in its closing position.

Advantageously, for example, said protective screen can be arranged to cover at least said first and/or second closing means.

Advantageously, said second closing means can be arranged at the end of said rod opposite to its hinged end.

Advantageously, a first and a second rod (9, 10) overlapping each other can be comprised.

Advantageously, a protective screen can be provided for each one of said rods.

Advantageously, the protective screen can be overlapping and fixed to any structural part of the cage.

For example, advantageously, the protective screen can be welded.

Advantageously, the cage can be constituted by a structure formed by a plurality of structural elements (5, 6, 7, 8) connected to each other, one or more of said structural elements being made of metal, e.g. steel.

A method to increase the cut-resistance of a protective cage intended to protect a cash machine is also described herein, the method comprising the phases of production of the structure at least partly of metal forming the cage and the fixing, to one or more areas of the cage, of a protective anti-cutting screen (20, 21) placed to cover said areas and with said protective screen constituted by at least two metallic layers between which at least one layer of ceramic material is interposed.

The use of one or more protective screens placed for anti-cut protection of a containment cage of cash machine is also described herein, in which each protective screen is constituted by at least two metallic layers between which at least one layer of ceramic material is interposed, which protective screen is applied for covering and for anti-cutting protection of one or more areas of the cage.

### BRIEF DESCRIPTION OF THE DRAWINGS

Further features and advantages of the present protective cage for a cash machine, according to the invention, will become clearer with the following description of some of its embodiments, made by way of example and not limitation, with reference to the accompanying drawings, wherein:

FIG. 1 and FIG. 2 show an axonometric view of the cage in accordance with the prior art;

FIG. 3 shows an axonometric view of a solution in accordance with the invention;

FIG. 4 shows a section of the protective screen to highlight its sandwich conformation which comprises ceramic material interposed between two layers of metallic material;

FIGS. 5 and 6 are further axonometric views of the protective cage according to a possible embodiment.

### DESCRIPTION OF SOME PREFERRED EMBODIMENTS

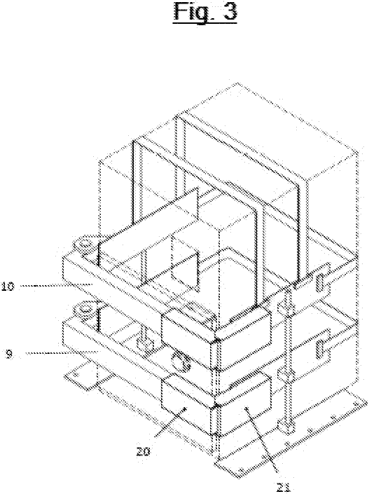

In accordance with the invention, FIG. 3 shows a solution in which a protective cover (also called protective screen) is provided that partially envelops the upper rod 10 and the lower rod 9.

In particular, the figure shows a part 20 and a part 21 which, when the relative rods are in the closing position, form a kind of angular part.

A first part 20 of said protective screen is applied to the end part of the relative rod 10 and 9, while the other part is applied to the insertion area of the locking pins.

The two parts are therefore separated from each other as highlighted in FIG. 5.

Therefore, when the relative rods 9 and 10 are in the closing position, an angular part is generated which is obtained by coupling the screen part 20 applied to the rod with the part 21 that will cover the closing means in the form of pins and/or padlocks that hook the rod. In this way, a de facto protection of the area relative to the cage closure and thus the area that is generally subject to cutting attempt is achieved.

In fact, the part relating to the pins 6 represents the weak point that the criminal tends to be able to cut to open the relative rod.

The angular part (20, 21) placed as a cover provides an additional protection against cutting.

In accordance with the invention, these screens are made of composite material such that they are particularly resistant to cutting with the grinding wheel and/or with the blowtorch.

The purpose of such protective screens is therefore to lengthen the times it takes to cut off the strategic parts of the device, thus discouraging the criminals from carrying out the attempted theft.

Said anti-cutting screens (20, 21) are constituted by materials commonly used in constructions and therefore of low cost, as is the characteristic of the entire structure.

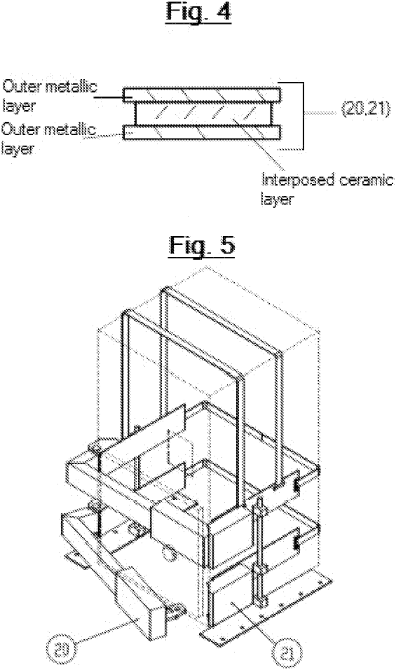

More in particular, as also schematised in FIG. 4, the anti-cutting screens are constructed with a layering of metal (e.g. steel) on the two outer sides and extra-hard ceramic is comprised in between.

Substantially, the two outer layers are provided which are a resistant metallic material such as for example steel and there is at least one inner layer, interposed between said two outer layers, which is made of ceramic material.

In particular, FIG. 4 shows the outer metallic layer, with outer being understood the visible part facing the outside of the cage;

The inner layer is then provided, with the inner layer being understood the one that in use faces the cage;

The interposed layer is then provided, or comprised between them as the case may be.

The resulting structure is therefore a sandwich structure that could envisage several ceramic layers interposed between several metallic layers, although the preferred configuration is that of FIG. 4.

The metallic layer is preferably steel.

The difficulty in cutting the sandwich thus obtained with a grinding wheel lies in the fact that the discs of the grinding wheel for cutting steel, commonly used, wear out very quickly in contact with ceramic; conversely, those used to cut ceramic do not cut steel.

Then, there are “diamond”-type discs that cut everything, but they must be used by expert hands by making a slow cut, taking a long time and avoiding reaching the overheating of the disc, which would lead to the degradation thereof.

As far as cutting with a blowtorch is concerned, it should be considered that ceramics have a much higher melting point than steel; moreover, a discontinuous thickness with materials of different kinds, (steel-ceramics- steel) makes cutting even with a blowtorch much more difficult.

The protective screen thus applied at critical points makes it much easier to protect against cutting.

The protective screen described, as mentioned, is preferably applied at the critical points that are generally cut, such as the area of the fixing pins of the upper 10 and lower 9 rods or in any case the areas where padlocks or closing systems in general are applied. However, the application of suitable protective screens suitably shaped in other parts of the cage is not excluded.

The sandwich protective screen is applied immovably, e.g. by welding.

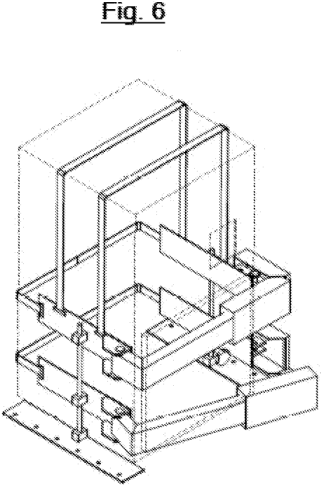

In particular, the solution for protecting the closures (6, 7 8) of FIGS. 5 and 6 provides for the use of a protective screen divided into two separate parts (20, 21) but which are interlocked together at an angle when the rod (9, 10) is in the closing position (see for example FIGS. 5 or 6). The part 21 is welded to the cover of the lock and remains fixed to protect the lock itself. The part 20 is welded to the rod 9 and moves with it when it is opened. The same applies to the rod 10.

FIG. 5 and FIG. 6 show this solution.

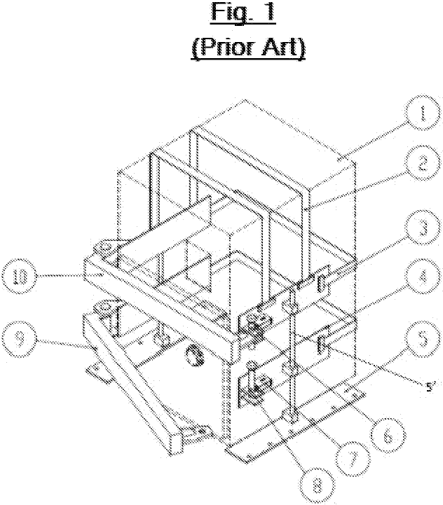

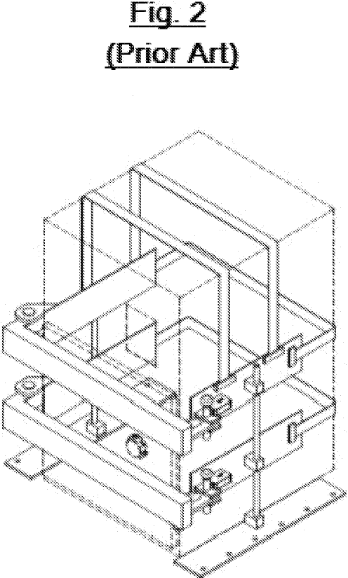

The new cage is therefore identical to the prior art of FIGS. 1 and 2 already described and to which reference is made, whereby the parts described in the prior art, for example the pins 6, the plates 5, the padlocks or locks 7 etc., are to be understood as being included in the solution object of the invention, as is also clearly evident from the figures. Obviously, with reference to FIGS. 3 to 6, the solution object of the invention further comprises said one or more protective screens (20, 21) which could be applied in one or more parts of the cage, in particular in the closing areas of the upper (10) and lower (9) rod in order to protect the closing means.

The application shown in FIGS. 5 and 6 of these protective screens is therefore not intended to be limiting.

In a further aspect of the invention, the new device, in addition to using the belts 3 already present in the prior art, has many strategic parts made of suitably welded steel that still maintains the necessary elasticity characteristics, but which considerably increase the resistance to breakage in the event of an explosion.

In particular, the parts known as “belts” have the characteristic of high tensile strength; they can be made of polyester, or they are stranded steel cables coated with aramid material. The other parts making up the cage are preferably all made of steel, with the various parts welded together, with the exception of the movable parts such as the hinges of the rods 9 and 10, the pins 6 and 8, the adjustable rods 5'.

The welds per se are not new as they are already used in the prior art described. However, on a product subject to strong pressure such as an explosion, they take on a certain importance and, for this reason, they preferably should be made according to the best welding technique by specialized welders, exploiting the entire weldable surface in the union of two pieces.

In all the configurations of the invention, such ceramic material may be in the form of ceramic tiles which are interposed between the two outer layers and fixed thereto, for example with glue material.

In all the configurations of the invention, the ceramic material, for example in the form of tiles, may be stoneware, for example porcelain stoneware.

The thicknesses of the protective screen can vary depending on the needs and the person skilled in the art will be able to freely find the most suitable sizes and thicknesses for the case.

Obviously, the higher the strength required, the thicker the metal will be, as a function of the type of metal selected and of the ceramic material interposed.

1. A protective cage for a cash machine (1) comprising for at least one part thereof at least one protective 5 anti-cutting screen (20-21) constituted by at least two metallic layers between which at least one layer of ceramic material is interposed.

2. The protective layer, according to claim 1, wherein 10 the said metallic layers are made of steel.

3. The protective cage, according to claim 1, wherein said layer of ceramic material is stoneware.

4. The protective cage, according to claim 1, wherein said ceramic material is in the form of ceramic tiles.

5. The protective cage, according to claim 1, wherein the said protective cage comprises first closing means (6, 7, 8) and at least one rod (10) rotatable between an opening position and a closing position and with said rod comprising second closing means suitable for engaging with the said 25 first closing means to lock the said rod when it is in its closing position, said protective screen being arranged to cover at least said first and second closing means.

6. The protective cage, according to claim 5, wherein said second closing means are arranged at the end of the said rod opposite to its hinged end.

7. The protective cage, according to claim 5, wherein a first and a second rod (9, 10) overlapping each other are comprised and wherein a protective screen is provided for each one of the said rods.

8. The protective cage, according to claim 1, wherein the protective screen is overlapping and fixed, preferably welded, to cover a part of the cage.

9. The protective cage, according to claim 1, wherein the cage is constituted by a structure formed by a plurality of structural elements (5, 6, 7, 8) connected to each other, one or more of said structural elements being made of steel.

10. A method to increase the cut-resistance of a protective cage intended to protect a cash machine, the method comprising the phases of production of the structure forming the cage and the fixing, to one or 20 more areas of the cage, of a protective anti-cutting screen (20, 21) placed to cover said areas and with said protective screen constituted by at least two metallic layers between which at least one layer of ceramic material is interposed.

11. The use of one or more protective screens, wherein each protective screen is constituted by at least two metallic layers between which at least one layer of ceramic material is interposed, the protective screen 30 is applied for covering and for anti-cutting protection of one or more areas of the cage.
